(19) United States
(12) Patent Application Publication
(10) Pub. No.: US 2011/0304728 A1
(43) Pub. Date: Dec. 15, 2011

(54) Video-Enhanced Optical Detector

(76) Inventors: Jeffrey C. Owrutsky, Silver Spring, MD (US); Daniel A. Steinhurst, Alexandria, VA (US); Christian P. Minor, Potomac, MD (US)

(21) Appl. No.: 13/159,262

(22) Filed: Jun. 13, 2011

Related U.S. Application Data
(60) Provisional application No. 61/354,038, filed on Jun. 11, 2010.

(51) Int. Cl. H04N 5/33

(52) U.S. Cl. 348/135; 348/E05.09

(57) ABSTRACT

The document describes a method of transforming available live video output from a camera into a format compatible for combination with existing single element detectors operating at various spectral bands to achieve improved performance for non-imaging, optical event detectors, especially for optical flame detectors. The method can utilize data that is becoming increasingly available because of the expanding deployment of surveillance cameras that are prevalent in many sensing and security devices and systems. Augmenting output from established OFD sensors with the data stream converted from the video output and incorporating viable algorithms can yield a detection method with improved performance with respect to both sensitivity and selectivity without requiring additional hardware deployment.

### CROSS-REFERENCE TO RELATED APPLICATIONS

This application claims priority to provisional patent application entitled, “LWVD Luminosity for Use in the Spectral-Based Volume Sensor Algorithms,” filed on Jun. 11, 2010, and assigned U.S. application Ser. No. 61/354,038; the entire contents of which are hereby incorporated by reference.

### FIELD OF THE INVENTION

The invention relates generally to event detection systems. More specifically, the invention relates to utilizing surveillance cameras with optical flame detectors in event detection, such as fire detection, systems.

### BACKGROUND

Economical fire and smoke detectors play an important role in residential and commercial security. The most prevalent sensors are typically point detectors, such as ionization, photoelectron, beam smoke detectors, and heat sensors. These sensors operate based on the transport or diffusion of source products (smoke, radiant heat, or emitted gases) to the detector. More recently, efforts have incorporated multi-criteria methods in which several different sensors are used in conjunction with a neural-net based analysis algorithm to decrease the response time and minimize the false alarm rate. These methods have been shown to achieve higher accuracy than a single sensor device. However, the detectors demonstrated were point sensors; and therefore, the overall approach is inherently slower than methods using remote sensing technologies, such as optical detection.

Optical flame detectors (OFDs) employ remote sensing methods capable of operating at a standoff distance. They can monitor a volume or space without relying on transport phenomena to operate so that in principle they can respond more quickly than a point detector to a flaming source. OFDs using one or more single-element optical detectors are commercially available. These devices typically sense emitted radiation in narrow spectral regions where flames emit strongly, including the UV, visible, and IR regions of the spectrum. Multiple sensors are often used either to detect different types of fires or for nuisance rejection. A few of these prior art devices are discussed below.

While the optimum detector configuration typically depends on the specific nature of the hazard and the environment of the intended application, a common feature of OFDs is detection of the strong CO₂ emission band near 4.4 μm. U.S. Pat. No. 4,455,487 to Wendt (“Wendt”) described a UV/IR OFD that could compare the ratio of UV to IR radiation to a known range for fire events. A fire alarm would be indicated only when the ratio was within this particular range. The method described in Wendt generated fewer false alarms than other existing UV/IR devices, which typically treat each detector output separately and use AND or NOR logic to combine the inputs for fire detection. The IR detector in Wendt was sensitive in the range of 4.1 to 4.7 μm. This range was appropriate for the detection of hydrocarbon fires such as fuels; however, not for hydrogen fuel sources.

U.S. Pat. No. 5,311,167 to Plimpton et al. (“Plimpton”) proposed a configuration that could simultaneously detect hydrocarbon and non-hydrocarbon fires using an IR detector sensitive in both the 4.4 and 2.9 μm ranges. Furthermore, rather than using UV detection for false alarm suppression, in U.S. Pat. No. 5,612,676, Plimpton added a reference IR detector to simultaneously detect incident light at 2.2, 3.7, and 5.7 μm, which are not wavelengths associated with flame emission, but rather wavelengths which are typically associated with non-flame sources such as sunlight.

The digital multi-frequency IR flame detector in U.S. Pat. No. 6,150,659 to Baliga et al. (“Baliga”) had two IR detectors to classify flame sources from background nuisances and to gauge the size of the fire. The primary (Flame) detector was an IR detector with a wavelength range of 4.2 to 4.8 μm. Two independent analysis pathways could determine the size of a detected flame source based on the frequency content of the signal. Baliga reported that the flicker rate of small fires is in the range of 2-12 Hz while the range is 40-100 Hz for large and/or steady fires. The second IR (Sun) detector operated at 2.0-2.4 μm. In addition to the absolute values for each data channel, the Sun/Flame ratio was compared to a previously determined threshold to discriminate flame sources from other sources. Instances that result in ratios that exceeded the threshold were classified as false alarms; and therefore, no alarm was indicated.

U.S. Pat. No. 6,756,593 to Nakauchi et al (“Nakauchi”) explored a method and IR/IR

OFD design using a narrow-band IR detector centered near 4.4 μm and a broad-band IR detector. Nuisance sources were effectively discriminated against by comparing the intensity ratio between the two bands.

Several studies have compared the effectiveness of commercially available OFDs of different configurations in typical fire scenarios of interest to military installations. In one particular study by Gott et al., they evaluated a wide range of detectors for fires in aircraft hangar bays and concluded that UV/IR dual OFDs were the most effective for typical hanger bay fire sources (e.g. fuel pool fires). In a later study, Gottuk et al. tested OFDs in aircraft hangars and found that triple IR detectors were more effective than units using either UV/IR or dual IR for the scenarios tested. OFDs were effective at monitoring a wide area, but they were primarily flame detectors and not very sensitive for smoldering fires.

One limitation of typical OFD methods is that they are most effective when there is direct line of site between the fire and detector. This limitation increases the number of sensors required to completely cover a given area, particularly if the area is heavily occupied/cluttered. OFDs are also not typically effective at detecting hot objects or reflected fire emission from source outside the direct line-of-sight or field of view (FOV), both of which would be desirable for a fire detection system.

Near IR (NIR) emission radiation detectors have also been used for a number of applications including remote detection of fire and flame characterization in turbines and burners. Typically, methods for the remote sensing of fire utilize either several narrow band detectors (without imaging) or NIR cameras (to provide imaging). One method for the former approach has been disclosed in U.S. Pat. No. 6,111,511 to Sivathanu et al. In this patent, two NIR detectors were used (at 900 and 1000 nm) to monitor a space. Time series and Discrete Probability Function numerical analyses were applied to the data for source detection. The results showed that the apparent source temperature was different for direct and reflected radiation from a hot emission source (flaming or smoldering).

NIR image detection has been applied in background-free environments, such as for monitoring forest fires from terrestrial-based and satellite images, tunnels, as well as aircraft cargo surveillance. Satellite-based NIR detection of forest fires has been effective in part because there are few if any interferences or nuisances to complicate the detection. For the heavily obstructed environments typical of loaded aircraft cargo holds and active compartments within naval ships, NIR imaging has been explored for flame and smoke detection. U.S. Pat. No. 7,280,696 to Zakrzewski et al. suggested a method for fire and smoke detection within aircraft cargo holds, which made use of CCD cameras filtered to only operate in the NIR. By alternating between several modes of illumination and detection geometry, the detection of fires that were significantly obstructed from the sensor was achieved along with smoke detection. The method was robust with respect to false alarms from common nuisance sources such as fog and dust.

For detection of flame within a crowded ship compartment, U.S. Pat. No. 7,154,400 to Owrutsky and Steinhurst described a method for the detection of flame both directly within the FOV of the camera and in reflection for flames not directly in the camera FOV. In this method, a standard silicon CCD camera was used in conjunction with a longpass optical filter that removed most of the visual spectrum image.

U.S. Pat. No. 6,518,574 to Castleman described an array OFD for flame detection with visible/NIR-based nuisance-rejection. The primary detector in this approach could detect radiant energy from a flame or other heat source using a broadband IR detector (700-3500 nm). A 4.3 μm IR detector for the detection of hydrocarbon fires assisted the primary detector in the data processing algorithms. Signal intensity in the visible (400-600 nm) and NIR (700-1000 nm) bands were used to detect radiant energy which was not fire related.

Finally, Steinhurst and Owrutsky proposed a multiple-element, non-imaging OFD configuration for shipboard situational awareness. The configuration included a 4.3 μm IR detector, a solar-blind UV detector, and three visible/NIR photodiodes (590, 766.5, and 1050 nm), all with narrow spectral bandwidths (i.e., 10 nm FWHM for the photodiodes). Data from these non-imaging detectors were combined within a series of data processing algorithms, which offered enhanced event detection (compared to multi-IR or IR-UV configurations) and superior classification performance (source vs. nuisance), especially for flame events, which were not located within the FOV of the sensor. The approach also provided positive classification of bright nuisances such as arc welding. The responses of the single-element optical detectors were used to develop a spectral intensity pattern or spectrum. Data processing algorithms were developed to classify sources as a directly viewed fire, a partial fire signature, such as one that might result from a fire viewed in (partial) reflection, or a bright nuisance, such as arc-welding. Sources that did not fall within any of these three categories were discriminated against as false alarms.

In summary, optical flame detectors have become widely used for flame detection in a variety of different applications. However, one limitation is that optical flame detectors are extremely expensive, and more and more expensive optical flame detectors were needed in order to provide adequate detection. Accordingly, there remains a need in the art to reduce the number of sensing elements required, while retaining as much performance as possible.

### SUMMARY OF THE INVENTION

The invention satisfies the above-described and other needs by providing for a method for using a video camera output as an optical flame detector to detect flame events. A space can be monitored with the video camera that is responsive in the near infrared. Image data can be retrieved with a near infrared spectral response using a long wavelength transmitting filter mounted on the video camera. The image can then be reduced to create a single data stream representing a near infrared spectral bandwidth data stream of the video camera output, wherein the single data stream is a substitute for a near infrared single element spectral sensor. Finally, the spectral bandwidth data stream can be analyzed in combination with one or more other single element narrow band spectral optical sensors to detect flame emissions.

These and other aspects, objects, and features of the present invention will become apparent from the following detailed description of the exemplary embodiments, read in conjunction with, and reference to, the accompanying drawings.

### BRIEF DESCRIPTION OF THE DRAWINGS

FIG. 1 illustrates schematically a Volume Sensor Prototype (VSP) system in accordance with a prior art event detection system.

FIG. 2 illustrates an installation position of a Volume Sensor Prototype (VSP) system in accordance with a prior art event detection system.

FIG. 3 illustrates an installation position of a Volume Sensor Prototype (VSP) system in accordance with an exemplary embodiment of the invention.

FIG. 4 illustrates the normalized outputs of the LWVD component and spectral sensors, 766 nm and 1050 nm.

### DETAILED DESCRIPTION OF EXEMPLARY EMBODIMENTS

Referring now to the drawings, in which like numerals represent like elements, aspects of the exemplary embodiments will be described in connection with the drawing set.

In summary, this document describes a method of transforming available live video output from a camera into a format suitable for combination with existing single element detectors operating at various spectral bands to achieve improved performance for non-imaging, optical event detectors, especially for optical flame detectors (OFDs). The method can utilize data that is becoming increasingly available because of the expanding deployment of surveillance cameras that are prevalent in many sensing and security devices and systems. Augmenting output from established OFD sensors with the data stream converted from the video output and incorporating viable algorithms can yield a detection method with improved performance with respect to both sensitivity and selectivity without requiring additional hardware deployment. The invention's higher flame detection probability and decreased false alarm rate to common nuisance sources demonstrate such improved sensitivity and selectivity.

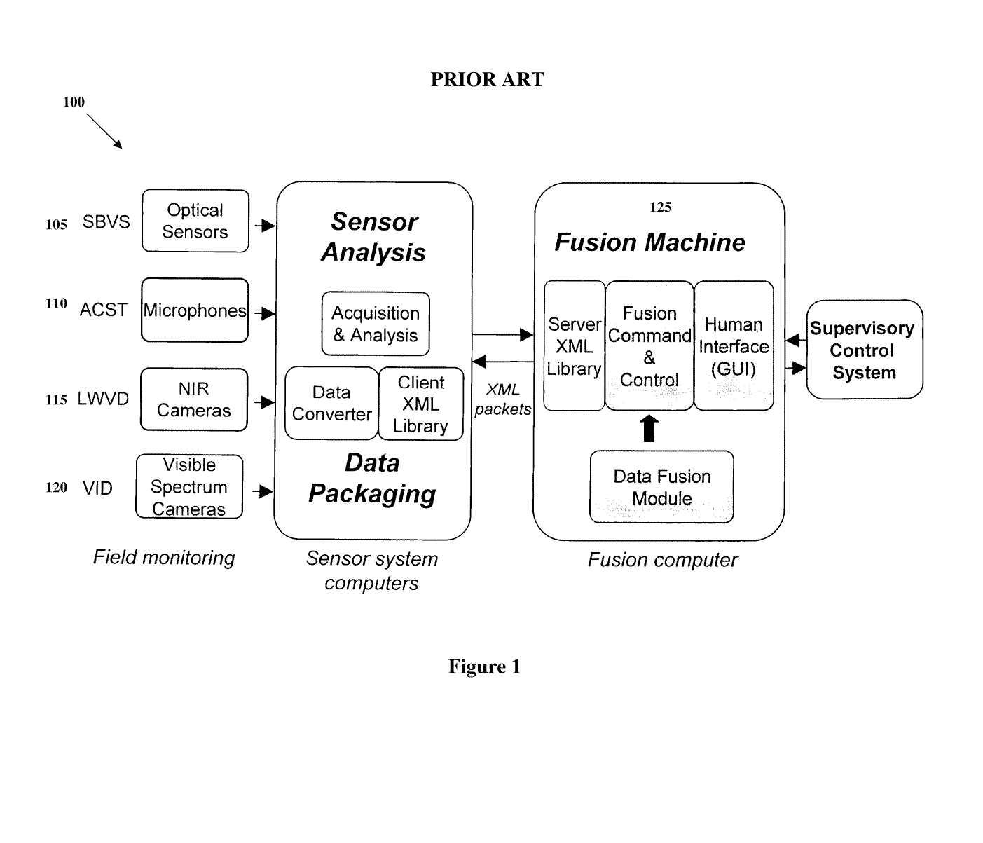

FIG. 1 illustrates schematically a Volume Sensor Prototype (VSP) system in accordance with a prior art event detection system. The system 100 is composed of several discrete subsystems including a Spectral-Based Volume Sensor (SBVS) component 105, an Acoustic component (ACST) 110, a Long Wavelength Video Detection (LWVD) component 115, and a Video Image Detection (VID) component 120. Each installation of each component 105, 110, 115, and 120 collects data, processes it through internal event detection algorithms, and determines a system state (e.g., detection of an active fire event). These data and event states are aggregated in several stages leading up to a VSP Fusion Machine 125, which ultimately provides compartment and larger scale situational awareness determinations.

A VSP system 100 installation typically has several component sensor devices subsystems, e.g., 105, 110, 115, and 120, collocated at each installation position, or sensor suite.

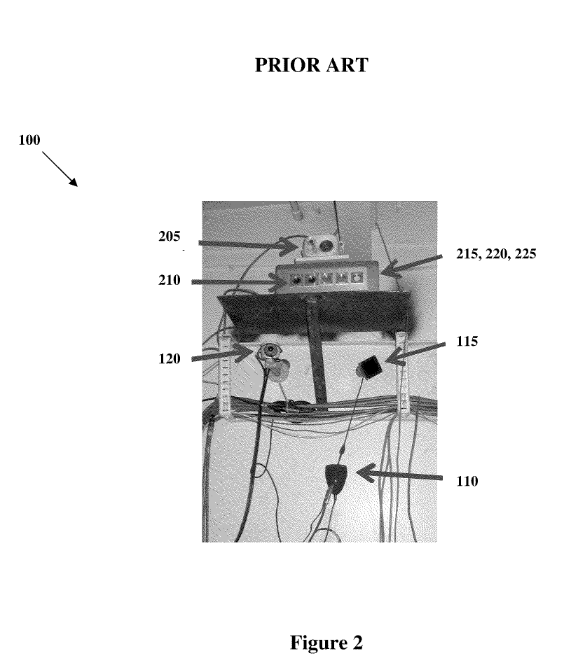

FIG. 2 illustrates an installation position of a Volume Sensor Prototype (VSP) system 100 in accordance with a prior art event detection system. Specifically, FIG. 2 shows a microphone, i.e. Acoustics Component (ACST) component 110, a filtered video camera, i.e., Long Wavelength Video Detection (LWVD) component 115, and a Video Image Detection camera (VID) component 120. Furthermore, there a five other components 205, 210, 215, 220, and 225 that are a part of the Spectral-Based Volume Sensor (SBVS) component 105. These components include an ultraviolet (UV) spectral sensor 205, an infrared (IR) spectral sensor 210, and three filtered photodiodes 215, 220, and 225. Specifically, the three filtered photodiodes included two sensors operating at visible (VIS) wavelengths, e.g., 589 nm 215 and 766 nm 220, as well as a sensor operating at a near-infrared (NIR) wavelength, e.g., 1050 nm 225.

One objective of designing a single sensor head was to reduce the number of sensors to reduce the size, cost, and complexity of the instrument or device hardware while retaining, to the extent possible, the performance achieved with the original system that includes all the sensors. Therefore, in order to reduce the number of components, attempts have been made to develop a single ‘sensor head,’ in which the set of VSP component systems can be housed in a single unit for ease of installation. In this regard, one aspect to accomplish this objective was to utilize data from one or more of the VSP components as a substitute for one of the other sensors that was being eliminated.

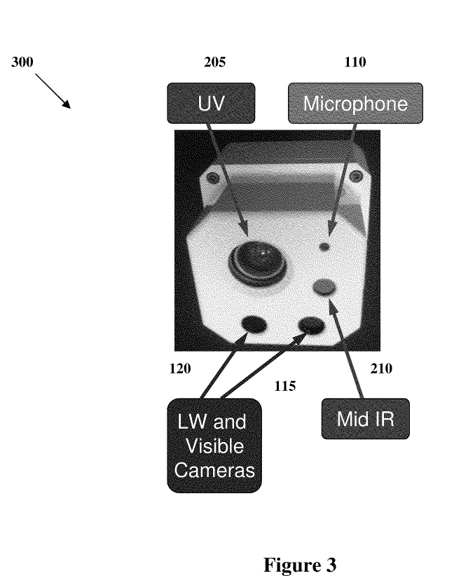

FIG. 3 illustrates an installation position of a Volume Sensor Prototype (VSP) system 300 in accordance with an exemplary embodiment of the invention. As illustrated, the VSP system 300 has been reduced to five sensors, including a microphone, i.e. ACST component 110; a near infrared filtered video camera, i.e., LWVD component 115; a VID camera component 120; an UV spectral sensor 205; and an IR spectral sensor 210. Therefore, three of the SBVS spectral sensor components 215, 220, and 225 were eliminated from the Prior Art VSP system 100 represented in FIG. 2.

In order to meet the objective to eliminate VSP components, the SBVS component 105 performance was evaluated. It was determined that eliminating one or more of the visible and NIR single element sensors 215, 220, and/or 225 in the SBVS component 105 was possible. To accomplish this, the collected data stream of the LWVD Component 115 was evaluated.

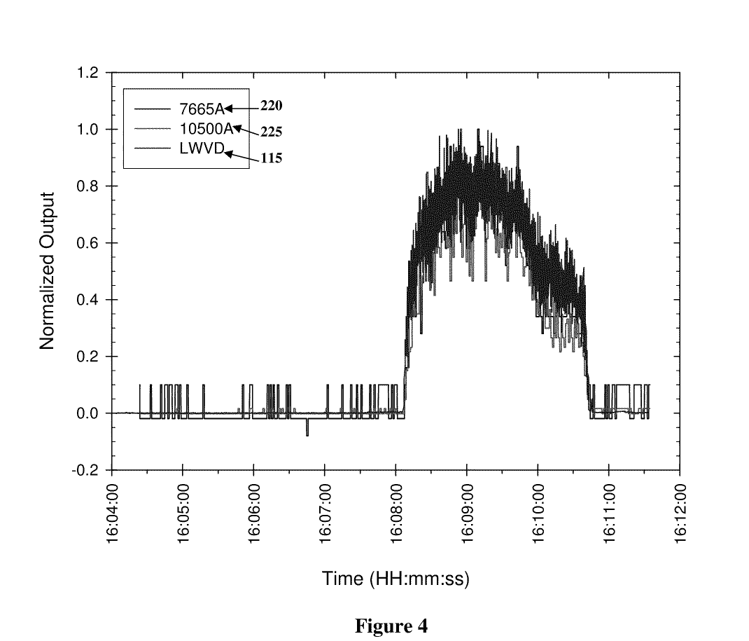

The LWVD Component 115 captures video images with a NIR spectral response (e.g., from approximately 700 to 1100 nm) using a NIR, long pass filter (e.g., collects only long wavelengths >720 nm) placed in front of a silicon-based CCD surveillance camera. These video images can then be converted into a luminosity data stream for event detection. More specifically, in an exemplary embodiment of the invention, the effective wavelength coverage of the LWVD camera and filter is from approximately 720 nm to 1100 nm. It was noted that in this setup, the Silicon-based CCD surveillance camera could provide an output data stream that strongly resembles that from the visible spectral sensor 220 and near infrared (NIR) single element sensor element 225 in the Spectral-Based Volume Sensor (SBVS) component 105 of the VSP system. FIG. 4 illustrates the normalized outputs of the LWVD component 115 and spectral sensors (766 nm) 220 and (1050 nm) 225. It is apparent that the normalized responses of the three sensor elements are very similar, as expected for sensor elements with overlapping detection wavelength ranges. Subsequently, this approach of converting the LWVD component 115 video data to a single data stream as an alternative to the NIR single element sensor 225 was investigated and demonstrated to provide improved flame detection performance compared to the UV 205 and IR sensors 210 alone. The results of the investigation and the demonstration of the video-enhanced optical fire detection improvements form the basis of the exemplary embodiment of the invention, and are discussed in more detail below.

Two distinct elements related to an exemplary embodiment of the invention are discussed herein. First, disclosed is a unique configuration of multiple single-element detectors as an OFD including the reduction of the video output of a camera into a pseudo-single-element detector for enhanced detection and classification of flaming sources and bright nuisances both within and outside the FOV of the detector. Secondly, disclosed are algorithms and configuration parameters, which can convert raw sensor data from these sensors and successfully analyze the data for source detection and classification of damage control events, such as flame events and bright nuisance events, e.g., arc welding.

In an exemplary embodiment of the invention, the detector configuration can include a pair of single-element spectrally narrow detector elements 205 and 210 and a NIR-filtered Si CCD camera as the LWVD component 115. The center optical wavelength of the IR single-element sensor 210 can be chosen to correspond to strong emission features from flaming sources. The most prevalent band used in commercial off-the-shelf OFDs is the strong IR 4.4 μm emission from the asymmetric stretching band of CO₂. Therefore, more specifically, the IR detector 210 can be a thermopile detector in combination with an optical interference filter can offer the necessary sensitivity and selectivity. Flaming sources also broadly emit in the UV portion of the spectrum (185 to 260 nm). Specifically, the UV detector 205 can be a gas-discharge tube detector can provide a favorable combination of high sensitivity to emission and spectral discrimination of UV over visible light; the long wavelength cut-off for detection is 260 nm.

As mentioned, in addition to the UV 205 and IR 210 sensors, the original SBVS component 105 configuration contained three filtered photodiodes 215, 220, and 225. Analysis showed that an SBVS component 105 configuration based on the UV 205, IR 210, and the 1050 nm filtered photodiode 225 sensors was typically the best performing three-component configuration. There are no sharp atomic emission features at this wavelength; therefore, only the broad emission from a flaming source in the NIR is detected in this configuration. However, the addition of a third sensor element such as 225 to an optical flame detector design can be cost-prohibitive and unnecessary based on the exemplary embodiment of the invention.

Video cameras are becoming more and more prevalent in their uses in society, and it was apparent there was an opportunity to leverage the existing hardware and infrastructure of the VSP system 300 to work with video cameras. The combined spectral bandwidth of the LWVD sensor component 115, which includes both the response of the Si CCD imager and the response of a long-pass filter with a nominal 720 nm cutoff, overlaps well with a 1050 nm (NIR) photodiode 225 originally included in the SBVS Component 105 hardware. Therefore, utilizing the detection of NIR emission by the LWVD sensor component 115 can provide a viable alternative to the 1050 nm single element detector 225 and can yield better SBVS component performance than with the UV 205 and IR 210 sensors by themselves. Therefore, in accordance with an exemplary embodiment of the invention, the SBVS component can include only three components—LWVD sensor component 115, UV 205 and IR 210 sensors.

In addition to utilizing the LWVD component 115 as a viable alternative to the 1050 nm single element detector 225, two additional filtered photodiodes 215 and 220 can be removed from the VSP system 300. First, as illustrated in FIG. 4, the normalized output of the LWVD component 115 resembles the output of the 766 nm spectral sensor 220. Therefore, the 766 nm spectral sensor 220 can be redundant in the system. Secondly, while the 589 nm sensor 215 can be useful for smoke detection a VSP system 100, the VID camera component 120 is more effective than the 589 nm sensor 215 at smoke detection. Therefore, the 589 nm sensor 215 can also be eliminated.

As noted, in an exemplary embodiment of the invention, the NIR-filtered Si CCD camera of the LWVD component 115 can produce an image with the spectral response due to the combination of responses from the CCD imager (with a long wavelength cut-off near 1000 nm) and a long-pass filter with a nominal 720 nm short wavelength cutoff. Luminosity, which is a measure of the image-averaged intensity, is defined as the summation of the intensity of each pixel in a video frame normalized for the image dimensions. The reference luminosity, L_{b}, can be taken as the luminosity value of a frame collected as background in the absence of a damage control condition. In an exemplary embodiment, the reference luminosity, L_{b}, can be collected at the beginning of data acquisition, e.g., 30 seconds. The background image associated with this reference luminosity frame can be stored in as a bitmap file (.BMP) for reference purposes. When the luminosity exceeds a threshold value, the condition is registered and counted as the basis for a persistence-based alarm criteria and is stored in a data file in real time for archival purposes and later analysis.

In order to use the LWVD Component 115 output in the SBVS algorithm, the two-dimension images need to be reduced to a single value per frame. This can be accomplished with a LWVD algorithm. In the LWVD component 115, the Luminosity, L, can be determined for each frame in real time and can be compared to an alarm threshold luminosity, Lₜₕ. In one embodiment, the Luminosity can be a numeric value between 0 and 1 that represents the ratio of the frame luminosity to the maximum frame luminosity. The alarm threshold can be determined from the reference Luminosity, L_{b}, using a non-linear scale in order to maintain a consistent detection response given varying levels of background illumination. In an exemplary embodiment, to mitigate the effects of large variations observed in the background luminosity, a non-linear relationship between the reference L_{b} and Lₜₕ is used:

Lₜₕ=2\sqrt{L_{b}}

which yields proportionally smaller thresholds for larger background luminosities.

The LWVD algorithm can operate by tracking the number of frames exceeding the alarm criteria, L>L_{b}+Lₜₕ, and can generate an alarm when a persistence criteria is met, which may be adjusted depending on the desired sensitivity and selectivity. Additionally, persistence can be used to discriminate against spurious bright nuisances such as flashes of light or a reflective object rapidly moving through the monitored space. For example, if the luminosity value only exceeds the alarm threshold luminosity for one frame, or a small number of frames, the persistence criteria may recognize that is merely a spurious reading, or false alarm, and not an actual damage control event. In that instance, an alarm may not be generated, as no action would be required. However, it is foreseeable that a “minor” alarm condition could be generated to prompt for additional surveillance of the area to determine the cause of the false alarm.

The luminosity of the NIR-filtered Si CCD camera 115 output can also provide data that resembles the NIR (1050 nm) photodiode 225. This result has been confirmed by comparing the responses of the 766 photodiode 220, 1050 nm SBVS photodiode 225, and the LWVD Component 115 Luminosity for several previous test cases. The LWVD Component 115 and 1050 nm diode 225 responses are typically very similar. See FIG. 4 as an example.

The Spectral-based Volume Sensor event detection algorithms are typically broadly based on the emission characteristics of fires and nuisance sources, and empirically refined using analysis of results from several fire detection test series carried out in shipboard compartments and other similar environments. These algorithms have previously been developed and implemented for real-time use. In a typical embodiment of the event detection algorithms, the reported events are EVENT, FIRE, FIRE_FOV, and WELDING. The EVENT event can provide a generic trigger, indicating that some, currently unclassifiable event is occurring in the FOV of the sensor. The algorithms for FIRE and FIRE_FOV event detection can compare the measured “spectrum” or pattern of sensor signal levels for the five sensors of the SBVS system 205, 210, 215, 220, and 225 to an empirically determined spectrum for an easily-detected flaming fire (a large fire, e.g., 70 kW, a fire in the sensor FOV, or a fire that is both) for the FIRE_FOV event, or to a more general spectrum for the FIRE event where the source may be smaller, out of the sensor FOV, or both. An algorithm for the positive detection for bright nuisance sources, such as arc welding, can also be included that can compare the measured spectrum with that of a bright nuisance source. Bright nuisance sources have been found to have little or no IR signal while being extremely intense in the visible and UV. Each detection algorithm can include thresholds for detector signals, e.g., a certain amplitude, and persistence, e.g., a certain duration, criteria to minimize false alarm reports due to transient detected signals. In an exemplary embodiment of the invention, the LWVD Luminosity can be used in the place of the NIR photodiode 225 data in these algorithms.

In an exemplary embodiment of the invention, all raw channel data, scaled channel data for the algorithms, and the algorithm results can be recorded locally on the data acquisition computer for archival purposes, such as in an ASCII file format. Individual sensor unit calibrations have been implemented to account for unit-to-unit variations in response sensitivity. The scaled sensor channel data and the algorithm outputs can also be forwarded to another device via Ethernet using UDP and an open XML-based communications protocol. This portion of the method allows the proposed method to work in a cooperative method with other systems for enhanced performance and capabilities of the overall system.

In summary, the VSP system 300 in accordance with an exemplary embodiment of the invention can provide a simplified installation that can demonstrate comparable performance with a limited sensor count, and have reduced costs for installation and maintenance. In an exemplary embodiment, the damage control event detection system 300 disclosed in this document can operate in a stand-alone fashion as an OFD. Additionally, this method can contribute as a single component to a multi-component, multi-criteria sensor system which fuses the data and results from multiple components and/or sensors to produce an overall broader picture in terms of the range of conditions monitored as well as the sensitivity and specificity for a particular type of event pertinent to situational awareness within a sensing volume. In this broader picture, the relevant data channels and algorithm results from several systems can be combined using data fusion techniques for a more comprehensive analysis than simple alarms based on Boolean logic (ANDs and ORs). Based on data patterns observed in this multi-component system, faster and/or more robust detection and classification of flaming events can be achieved.

The invention comprises a computer program that embodies the functions described herein and illustrated in the appended flow charts. However, it should be apparent that there could be many different ways of implementing the invention in computer programming, and the invention should not be construed as limited to any one set of computer program instructions. Further, a skilled programmer would be able to write such a computer program to implement an exemplary embodiment based on the flow charts and associated description in the application text. Therefore, disclosure of a particular set of program code instructions is not considered necessary for an adequate understanding of how to make and use the invention. The inventive functionality of the claimed computer program will be explained in more detail in the following description read in conjunction with the figures illustrating the program flow.

It should be understood that the foregoing relates only to illustrative embodiments of the present invention, and that numerous changes may be made therein without departing from the scope and spirit of the invention as defined by the following claims.

1. A method for using a video camera output as an optical flame detector to detect flame events, comprising the steps of:
monitoring a space with the video camera that is responsive in the near infrared;
retrieving image data with a near infrared spectral response using a long wavelength transmitting filter mounted on the video camera;
reducing the image data to create a single data stream representing a near infrared spectral bandwidth data stream of the video camera output, wherein the single data stream is a substitute for a near infrared single element spectral sensor; and
analyzing the spectral bandwidth data stream in combination with one or more other single element narrow band spectral optical sensors to detect flame emissions.
